(19) United States
(12) Patent Application Publication
(10) Pub. No.: US 2016/0139949 A1
(43) Pub. Date: May 19, 2016

(54) VIRTUAL MACHINE RESOURCE MANAGEMENT SYSTEM AND METHOD THEREOF

(71) Applicant: HEWLETT-PACKARD DEVELOPMENT COMPANY, L.P., Houston, TX (US)

(72) Inventors: Kishore Jagannath, Bangalore (IN); Adarsh Suparna, Bangalore (IN); Ajeya H. Simha, Bangalore (IN)

(21) Appl. No.: 14/898,636

(22) PCT Filed: Jul. 19, 2013
(86) PCT No.: PCT/US2013/051311

§ 371 Date: Dec. 15, 2015

(51) Int. Cl. G06F 9/455; G06F 9/50

(52) U.S. Cl. CPC G06F 9/45558; G06F 9/5077; G06F 2009/4557; G06F 2009/45562

(57) ABSTRACT

Implementations of the present disclosure provide a virtual machine resource management system and method thereof. According to one implementation, a request for service provisioning is received and at least one virtual machine associated with the request is created. When a determination has been made that the allocated virtual resources have exceeded a threshold value, a virtual machine is modified based on an associated life cycle stage priority or service information.

### BACKGROUND

Cloud computing has become ubiquitous in today's society and generally consists of multiple physical machines running multiple vertical machines for sharing resources amongst computing systems. These virtual machines are the building blocks of cloud-based data centers, particularly in the creation of private, public, and hybrid cloud systems. Moreover, Virtual Machines (VMs) offer great benefits in terms of compatibility, isolation, encapsulation and hardware independence along with additional advantages of control and customization.

In a typical data center, several VMs are created by different groups and for different purposes to host a variety of business services. Since virtual machines are configured to behave in the same manner as a physical machine, the presence of a large number of VMs—due to the ease of VM creation—can sometimes result in VM sprawl in which the number of virtual machines created becomes so large that they strain the physical resources and thus adversely affect the overall performance of all VMs within the cloud environment.

### BRIEF DESCRIPTION OF THE DRAWINGS

The features and advantages of the present disclosure as well as additional features and advantages thereof will be more clearly understood hereinafter as a result of a detailed description of implementations when taken in conjunction with the following drawings in which:

FIG. 1 illustrates a simplified block diagram of a virtual machine resource management system according to an example implementation.

FIG. 2 illustrates another block diagram of the virtual machine resource management system according to an example implementation.

FIG. 3 illustrates a simplified flow chart of a method for virtual machine resource management according to an example implementation.

FIG. 4 illustrates a sequence diagram of a method for virtual machine resource management according to an example implementation.

FIG. 5 illustrates a simplified flow chart of the processing steps for evaluating virtual machines within the virtual machine resource management system in accordance with an example implementation.

FIG. 6 illustrates a simplified flow chart of the processing steps for deprovisioning virtual machines within the virtual machine resource management system in accordance with an example implementation.

### DETAILED DESCRIPTION OF THE INVENTION

The following discussion is directed to various examples. Although one or more of these examples may be discussed in detail, the implementations disclosed should not be interpreted, or otherwise used, as limiting the scope of the disclosure, including the claims. In addition, one skilled in the art will understand that the following description has broad application, and the discussion of any implementations is meant only to be an example of one implementation, and not intended to intimate that the scope of the disclosure, including the claims, is limited to that implementation. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

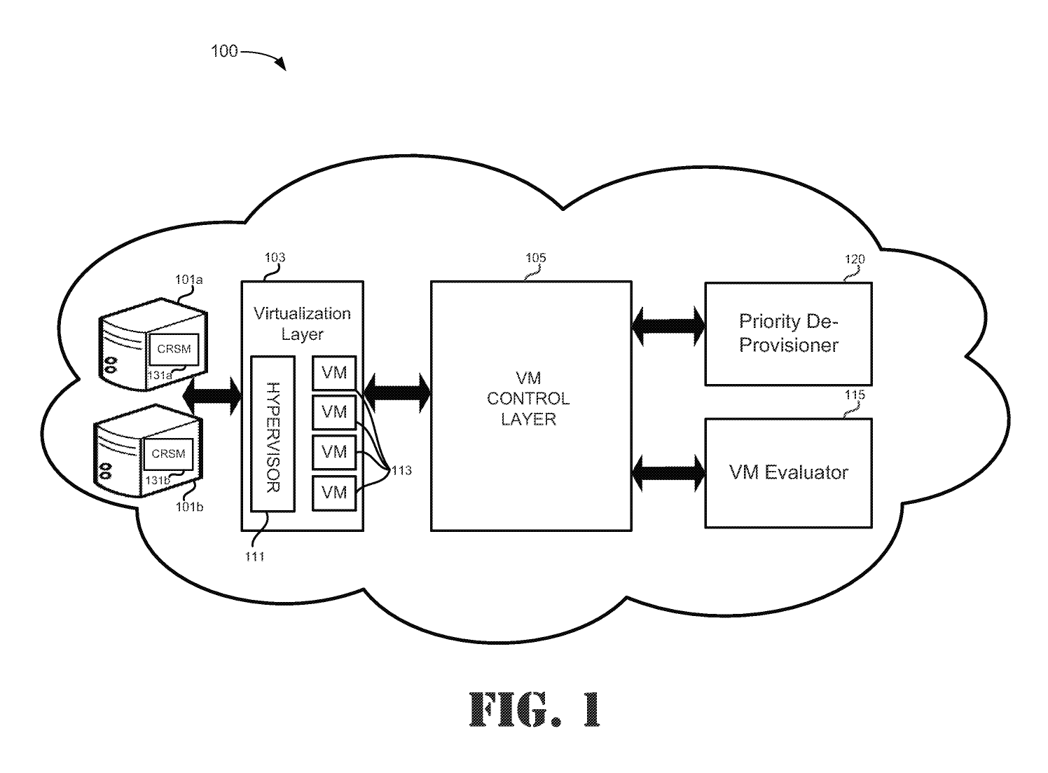

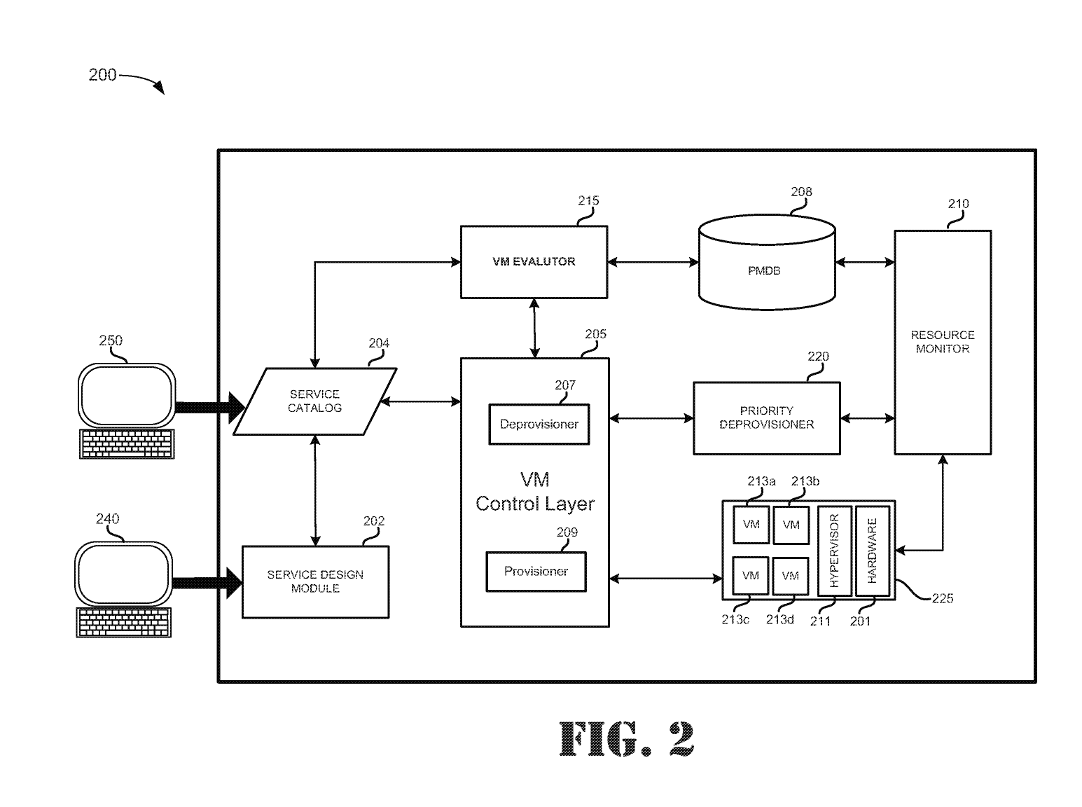

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Cloud architectures aid in providing services such as Infrastructure-as-a-Service (IaaS), Platform-as-a-Service (PaaS), or Software-as-a-Service (SaaS) amongst others. With respect to IaaS, this cloud architecture utilizes physical services running virtual machines, the creation of which is relatively simplistic. For instance, a large number of VM's may be created in an enterprise cloud simply using templates of service catalogs. However, the ease of VM creation eventually leads to an overabundance of necessary VMs necessary for the business, also known as VM sprawl. Over a period of time, virtual machines become stale and due to various factors like changes in requirements, changes in services or several other environmental factors; no longer serve the purpose for which they were created yet still consume precious resources and incur unnecessary cost to the host organization. VM sprawl is much more pronounced when there is no capacity left for creating critical environments like production or staging environments, possibly causing delays in product releases.

In a typical data center, VMs are created to deploy services or group of services. Some of the important short comings today are that data center administrators cannot decide on the necessity of VM's by managing and monitoring servers (VMs) because monitoring parameters for VMs are different than that of services. Presently, agent-based and similar monitoring solutions are configured to monitor the CPU, memory, I/O disk, I/O network of virtual machines. Moreover, categorizing a low-performing VM as stale is often risky as the VM could be hosting a service which is underutilized or the VM is oversized. As such, in order to properly determine the usefulness of a particular VM, the service rather than server needs to be monitored. More particularly, the specific service has to be monitored and verified to check the reason of deployment for hosting the service in order to make a proper decision on whether the VM is being used effectively and is still necessary. Thus, there is a need in the art for monitoring and managing services independently instead of just the servers or virtual machines associated therewith.

Today, there is no automated way to identify VMs which are underutilized based on the services deployed. Instead, data center administrators must manually verify the service's activity, which is a time-consuming and error-prone activity while doing manually. In data centers and production environments, services constantly move to different virtual machines having varying capacities based on load, performance, and the like, such that older or underutilized virtual machines remain with no specific purpose. These virtual machines need to be automatically cleaned so that the resources can be reclaimed. For example, clients/consumers often require the latest service version, which requires older services to become upgraded or withdrawn and render the previous VM and associated service version obsolete. However, monitoring the VMs or servers does not give the accurate utilization of the service or group of services associated with the VM. For instance, sometimes the virtual machines may appear to be in proper order, but the services inside the VM's may be unresponsive or unstable, and thus unused. As such, the associated virtual machines are not serving the proper purpose and there need is a need for an automated way to identify and remove such virtual machines in order to aid in VM sprawl prevention.

For instance, consider the case where the number of users in a datacenter is high for its capacity and all the VMs are active. The virtual resource capacity has reached its threshold and a development team wants to set up a staging environment to reproduce and analyze a critical bug found during production. In such a scenario, none of the existing approaches would be effective and could potentially create delays in day to day activities and even hamper production activities. This is because as the workforce increases with time, the ratio of the infrastructure capacity to the number of users keeps reducing to a point in which the number of active VMs exceeds the threshold. At such a time, there will be no VM's available for high priority environments like staging or production.

One prior solution for detecting VM sprawl involves manually tracking the VM's in a spreadsheet such that when the number of VMs exceeds a particular threshold, the idle VMs are deprovisioned, the owner of the VM is notified, and the VM is deleted or archived. Here, VM creation involves an approval from an administrator that controls the total number of VMs created. However, these manual processes are tremendously laborious as it requires an administrator to control and monitor each of the created VMs. Another solution involves the use of monitoring software to monitor the VMs based on usage, and then archiving VMs that have been idle or dormant for a predetermined time. However, these software methods are simply configured to identify inactive VMs and only eliminate unused VMs. Further solutions include expanding the infrastructure capacity by moving from a private cloud to a public cloud. However, such a move could result in higher cost and also pose security problems for users. As such, each of the aforementioned solutions are lacking in some respect and are insufficient in properly detecting and resolving issues associated with VM sprawl.

Implementations of the present disclosure provide a system and method for resource management of virtual machines. The proposed solution describes a way to identify virtual machines that are no longer necessary based on the hosted service and service catalog in addition to preemptively deprovisioning VMs based on a life cycle stage priority. As a result, resources can be reclaimed so as to provide more effective resource utilization and cost savings. Such a solution will help data center administrators control unnecessary VM sprawls and ensure that all virtual resources are being used efficiently at all times.

Referring now in more detail to the drawings in which like numerals identify corresponding parts throughout the views, FIG. 1 illustrates a simplified block diagram of a system for virtual machine monitoring and deprovisioning according to an example implementation. Environment 100 is shown to include a system for managing resources in a cloud environment. The system for managing virtual machines within a cloud system, described herein, represents a suitable combination of physical components (e.g., hardware) and/or programming instruction to execute the present implementations.

As illustrated in FIG. 1, a cloud system 100 can include a public cloud system, a private cloud system, and/or a hybrid cloud system. For example, an environment 100 including a public cloud system and a private cloud system can include a hybrid environment and/or a hybrid cloud system. A public cloud system can include a service provider that makes resources available to the public over the Internet. A private cloud system can include computing architecture that provides hosted services to a limited number of people behind a firewall. For instance, a private cloud system can include a computing architecture that provides hosted services to a limited number of computers behind a firewall. A hybrid cloud, for example, can include a mix of traditional server systems, private cloud systems, public cloud systems, and/or dynamic cloud services. For instance, a hybrid cloud can involve interdependencies between physically and logically separated services consisting of multiple systems. A hybrid cloud, for example, can include a number of clouds (e.g., two clouds) that can remain unique entities but can be bound together. For instance, the public cloud system and the private cloud system can be bound together, for example, through the application in the public cloud system and the virtual machines resource management system in the private cloud system.

Referring to FIG. 1, the cloud architecture 100 may include physical host servers 101a and 101b, a virtualization layer 103, VM control layer 105, priority deprovisioner 120, and a VM evaluator 115. Moreover, the cloud computing environment 100 includes at least one computer system or host server (e.g., 101a and 101b), which is operational with numerous other general purpose or special purpose computing system environments or configurations and may include, but is not limited to, personal computer systems, server computer systems, mainframe computer systems, laptop devices, multiprocessor systems, microprocessor-based systems, network personal computers, and distributed cloud computing environments that include any of the above systems or devices, and the like. Moreover, the host server system (e.g., 101a or 101b) may be described in the general context of computer system-executable instructions stored on a computer readable storage, such as program modules, being executed by a computer system. Generally, program modules include routines, programs, objects, components, logic, data structures, and so on, that perform particular tasks or implement particular abstract data types. The host server (e.g., 101a or 101b) may be implemented in distributed cloud computing environments in which tasks are performed by remote processing devices coupled via a communications network. In such an environment, program modules may be located in both local and remote computer system storage media including memory storage devices.

Host servers 101a and 101b include, at least one central processing unit (CPU), at least one semiconductor-based microprocessor, at least one graphics processing unit (GPU), and/or other hardware devices suitable for retrieval and execution of instructions stored in an associated machine-readable storage medium 131a and 131b, or combinations thereof. For example, the processor may include multiple cores on a chip, include multiple cores across multiple chips, multiple cores across multiple devices, or combinations thereof. Processor may fetch, decode, and execute instructions to implement the virtual resource management system described herein. As an alternative or in addition to retrieving and executing instructions, processor may include at least one integrated circuit (IC), other control logic, other electronic circuits, or combinations thereof that include a number of electronic components for performing the functionality of the present implementations. Still further, machine-readable storage medium 131a and 131b may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. Therefore, the machine-readable storage medium can be non-transitory. As described in detail herein, machine-readable storage medium 131a and 131b may be encoded with a series of executable instructions for providing virtual resource management as described herein.

One or more applications can be executed by the host servers 131a and 131b. In some examples, the applications are different from an operating system or virtual operating system which may also be executing on the computing device. In one example, an application represents executable instructions or software that causes a computing device to perform useful tasks beyond the running of the computing device itself. Examples of applications and virtual applications can include a game, a browser, enterprise software, accounting software, office suites, graphics software, media players, project engineering software, simulation software, development software, web applications, standalone restricted material applications, etc.

In one example, the virtualization layer 103 includes a hypervisor and a plurality of virtual machines 113. Hypervisor 111 represents computer software, firmware, or hardware configured to create and run virtual machines. As will be appreciated by one skilled in the art, virtual machines 113 may be created for different application lifecycle stages such as development, quality assurance, staging, or production for example. According to one implementation, each of these stages may be designated with a different priority based on the criticality of the assigned lifecycle stage. For instance, a staging or quality assurance environment/life cycle stage may be assigned or designated with a higher priority than a development environment/life cycle stage.

Still further, virtualization layer 103, including hypervisor 111 and virtual machines 113, facilitate the creation of a plurality of virtual resources that can be drawn from physical resources (physical servers 101a and 101b). The virtualized resources may include hardware platforms, operating systems, storage devices, and/or network resources, among others. However, the virtualization layer 103 is not directly limited by the capabilities of particular physical resources (e.g., limited to a physical proximity to a location associated with the particular physical resource).

The VM control layer 105 enables a user to provision and deprovision virtual machine templates from the virtualization layer 103. In one example, VM controller layer 105 represents an IaaS for creating infrastructure on any service provider. Accordingly, an operating user may be able to provision/deprovision single or multiple VMs 113 in a single request to the VM control layer 105.

Priority deprovisioner 120 communicates with the VM control layer 105 and is configured to prioritize VMs based on an associated life cycle stage and deprovision the low priority VMs when a higher priority VM needs virtual resources so as to ensure that the number of provisioned VMs remains under a predetermined threshold. The predetermined threshold value may be set by the administrator or automatically by the VM controller or hypervisor based on the maximum capacity and performance limits associated with the physical servers. For example, a threshold value may be set to allocate a certain amount of virtual resources given the size or performance of the CPU, memory, storage, network, operating system or the like associated with the host servers 101a and 101b.

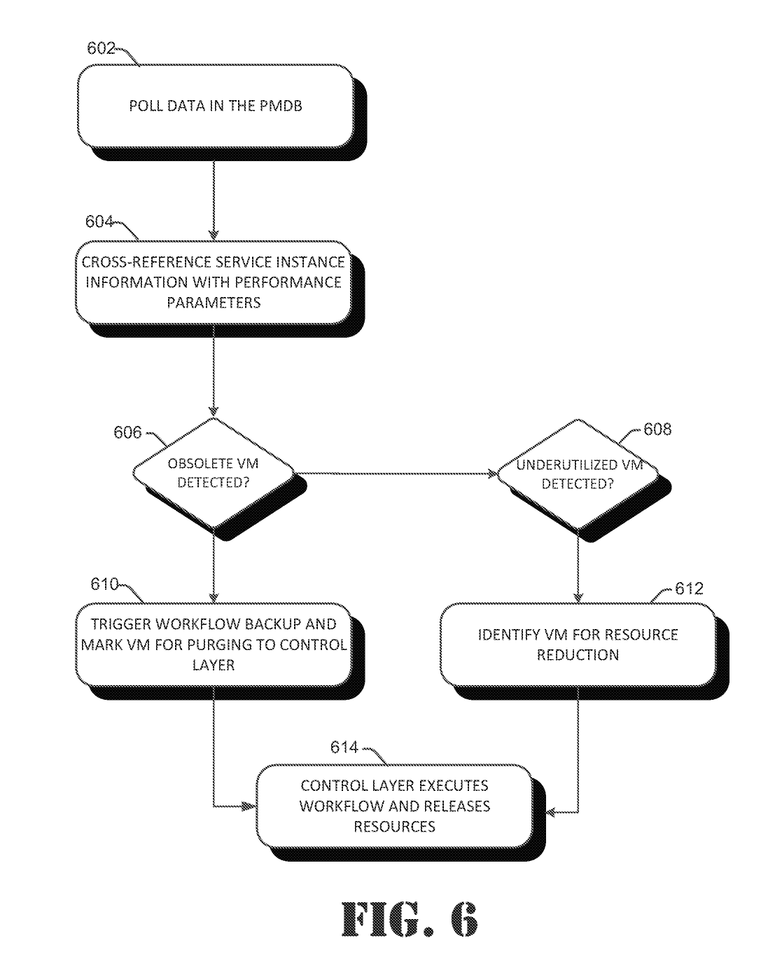

The VM evaluator 115 is configured to identify the stale VMs by polling the performance of associated services from a database. Moreover, the VM evaluator 115 communicates with the VM control layer to modify (purge obsolete VMs, reduce virtual resources) VMs based on the service performance of particular VMs as will be described in in further detail with reference to FIG. 6.

FIG. 2 illustrates another block diagram of the system for virtual machine resource management according to an example implementation. The system 200 of the present disclosure includes a service design module 202, service catalog 204, VM evaluator 215, VM control layer 205, performance management database (PMDB) 208, resource monitor 210, priority deprovisioning module 220, and host or network server 225. The service design module 202 is utilized by a cloud administrator 240 to create service templates for selection by a user. In one implementation of the present disclosure, a template describes one or more server configurations that comprise an infrastructure solution such as physical and/or virtual servers, computing power, or network connections for example. That is, various kinds of templates may be created by the administrator 240 for various purposes. For instance, a data center may include hundreds of such templates that are created with different permutations and combinations. According to one implementation, a user 250 may select any one of the pre-defined templates created by the administrators 240 to deploy a service. In some examples, a request for services can be provided via a client device 250 and selection of a service template by a user. Client device 250 can represent suitable computing devices with browsers and/or communications links, and the like, to receive and/or communicate such requests, and/or process the corresponding responses (e.g., select service template from catalog.

As used herein, a service represents an instance of an infrastructure for example and is created based on the template. In some examples, the service instances have lease end dates, and within a product environment VMs often become stale before the lease end date as service deployers and/or administrators tend to overestimate the lease period. Thus, the resulting service instance needs to be monitored and managed.

According to one example implementation, the VM evaluator 215 is configured to identify stale VMs by polling the associated service's performance from the PMDB 208. The resource monitor 210 represents an agent-based or agent-less monitoring solution and/or application performance monitoring solution configured to gather the metrics for a particular service, hosting application, and VM performance parameters at regular intervals and populate them into the PMDB 208. Since each deployed service instance serves a specific purpose, monitoring parameters can be customized while deploying or during post-deployment. Examples of the performance parameters utilized by the VM evaluator 215 include the service availability, service performance in terms of response time for real user monitor (RUM) or End User monitoring (EUM), the number of access request to the applications hosting the service including the number of user requests made to the web servers, database, SAP, ERP, CRM applications etc., and the hosting VM status (e.g., disk usage, I/O operations, network operations, CPU usage, etc.). In one implementation, the service instance contains the information about each virtual machine and the services deployed thereon. For services which are no longer getting used/accessed, the VM evaluator 215 may use the service instance and cross-reference the performance parameters in the PMDB 208 to identify stale or obsolete VMs which are no longer required in the data center. For example, when a low-performing service instance is identified, the VM evaluator 215 and VM control layer may use preconfigured instructions for executing one of the several modification actions including: purge the virtual machine; back up the virtual machine data and purge the virtual machines; reduce the resources (CPU, memory, storage, etc.) associated with the virtual machines; or combine applications on two or more virtual machines to one virtual machine.

Consequently, the cloud administrator need not manually go through each VM and the hosting service to verify if the VM is being optimally utilized. In addition, the administrator could schedule an automatic workflow to be taken on the identified stale VM (e.g., purge and/or backup to a drive and free the CPU, memory, network resources). VM evaluator 215 is further configured to activate the predefined workflow and trigger the VM control layer 205 to take an appropriate modification action (e.g., reduce resources, purge VM) on the identified VM (low-performing, obsolete).

The VM control layer 205 interacts with network server 225 and serves as the gateway for creating and deleting all infrastructures. More particularly, the VM control layer 205 includes a provisioner 207 and deprovisioner 209 for provisioning and deprovisioning VMs from the network server 225, which includes physical servers or hardware 201, hypervisor 211, and VMs 213a-213d. Additionally, the VM evaluator 208 may also serve as part of the VM control layer 205 in creating and deleting VMs (e.g., 213a-213d).

As described above, the priority deprovisioner 220 is configured to communicate with the VM control layer 205 for prioritizing VMs 213a-213d based on an associated life cycle stage. As VMs 213a-231d are added to the infrastructure and consume more virtual resource, the priorities of the provisioning request for each VM are analyzed such that lower-priority provisioning requests are marked for deprovisioning by the priority deprovisioner 220 upon detection of the virtual resources exceeding the predetermined virtual resource threshold. According to one example, the allocation of virtual resources may be based on the physical resources associated with network or host server 225. That is, the virtual resource allocation and threshold may be set to maximize the resources (e.g., CPU, memory, or storage) of the associated physical server such that the virtual resources do not consume more than the physical resources of the host server 225. In one implementation, as low-priority provisioning requests are identified upon the threshold being exceeded, the priority deprovisioner module 220 sends deprovisioning instructions (for the identified provisioning request) to the deprovisioner 207 of the VM control layer 205.

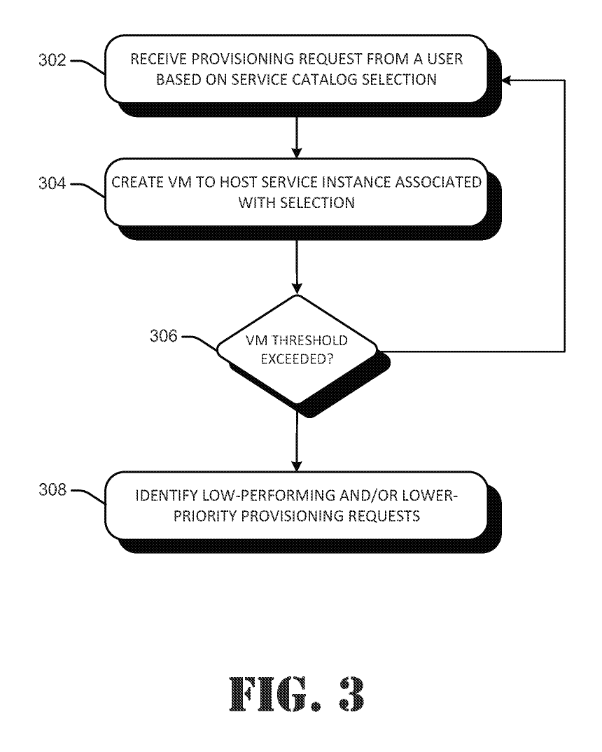

FIG. 3 illustrates a simplified flow chart of a method for virtual machine resource management according to an example implementation. In step 302, a provisioning request is received from a user operating the service catalog. During a provisioning request, the VM control layer gathers infrastructure-related data (e.g., number of processors, RAM size, hard disk size, guest operating system, etc.) in addition to VM data including the lifecycle stage for which the provisioning request is made, the user ID, and the VM persistence. These details are stored in a data structure which stores all provisioning requests.

According to one implementation of the present disclosure, each provision request includes a lifecycle stage (e.g., production stage staging stage, quality assurance stage, development stage, etc.) of the application which will be eventually deployed on these virtual machines. Furthermore, each lifecycle stage has a priority level associated therewith. For instance, the production life cycle stage may be assigned a first priority level; the staging life cycle stage may be assigned a second priority level; the quality assurance life cycle stage may be assigned a third priority level; while the development life cycle stage may be assigned the fourth and lowest priority level. The lifecycle stages along with their priorities are stored in a master data structure. Additionally, a unique identifier is stored that identifies the user issuing the request for a virtual machine.

The persistence level indicates whether the virtual machine can be forcefully deprovisioned and in accordance with one example, can be either true or false. If set to true, the VM(s) created as part of the request are not considered for deprovisioning. The cloud administrator may also be able to set policies to control the number of persistent virtual machines allocated to a user. For Instance, if there is a policy such that each user has a quota of one persistent VM, then such a policy may be enforced during the provisioning request. The above data should be available for each of the provisioned VMs and will be utilized by priority deprovisioner module to prioritize the provisioned VMs. Thereafter, in step 304 the VM control layer creates a service instance associated with the catalog selection. Once a predetermined virtual resource allocation threshold is exceeded in step 306, low-performing and lower-priority services are identified and deprovisioned based on the service instance/performance information and the life cycle stage priority associated with at least one currently provisioned VM and the life cycle stage priority associated with the new service request in step 308. For instance, a VM and/or service associated with a development life cycle stage may be deprovisioned in favor of a provision request associated with a production life cycle stage.

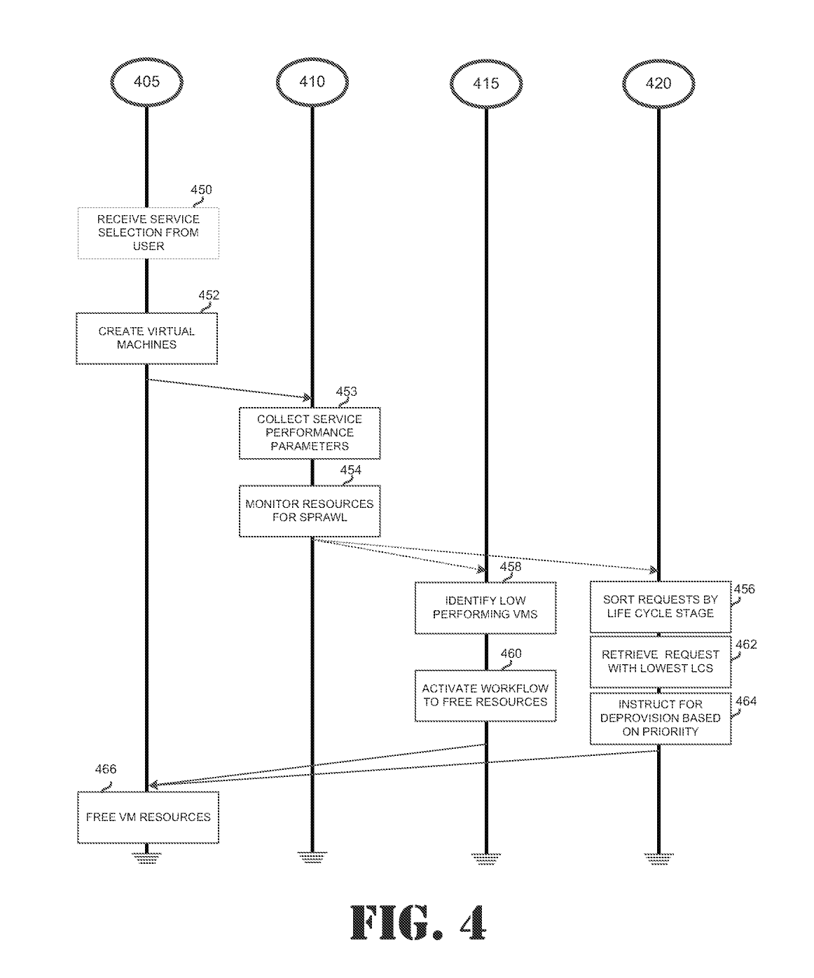

FIG. 4 illustrates a sequence diagram of the method for providing virtual machine monitoring and deprovisioning according to an example implementation. First, a request for provisioning services associated with a service template is received at the VM control layer 405 in segment 450. In response thereto, the VM control layer 405 creates at least one virtual machine associated with the provisioning request in segment 452. In segment 453, the resource monitor 410 gathers the metrics for a particular service, hosting applications, and VM performance parameters at regular intervals and populates them into the performance management database. The VM resource monitor 410 continuously monitors the provisioned VM and services in the datacenter via the PMDB for capacity and performance related parameters in segment 454. Once the resource monitor 410 detects that the capacity of the provisioned VMs has reached or is above the virtual resource threshold level, the resource monitor 410 may send a notification to the cloud administrator. Certain management tools can automatically deprovision orphaned virtual machines which have been lying dormant or inactive for long period of time. If the latest provisioning request causes the total capacity of VMs to rise above the threshold level, then the VM evaluator 415 identifies low-performing VMs in block 458 while the priority deprovisioner module 420 is activated and sorts the provisioning requests by their associated life cycle stage priority in block 456. In addition, the priority deprovisioner module 420 retrieves the lifecycle stage having the lowest life cycle stage priority in segment 462. Upon identification of low-performing VMs, the VM evaluator 415 activates a workflow to have the identified VMs purged. Additionally, the priority deprovision module 420 is configured to request deprovisioning of low-priority VMs based on the life cycle stage priority in block 464.

For example, the priority deprovisioner 420 may request deprovisioning of VM environments starting with the lowest priority life cycle stage (e.g., development environment stage). In one implementation, if there are no VMs to be de provisioned in the lowest life cycle stage priority, the next lowest life cycle stage may be deprovisioned. For example, if there are no more development environments (lowest priority) to be deprovisioned, than the quality assurance environments (second lowest priority) may be designated for deprovisioning by the priority deprovisioner module 420. According to one example, the priority deprovisioner module 420 may be configured to run the deprovisioning service until the virtual resource capacity reaches below the predetermined threshold value. Lastly, the VM controller 405 is notified of the low-performing and low-priority VMs and acts (e.g., instructions to hypervisor) to have the identified VMs purged or deprovisioned accordingly so as to free the VM resources in block 466. Additionally, the respective owners of the virtual machines may be notified of the deprovisioning activity. Still further, the VMs may be archived as part of the deprovisioning process so that the location of the archived instance is also communicated.

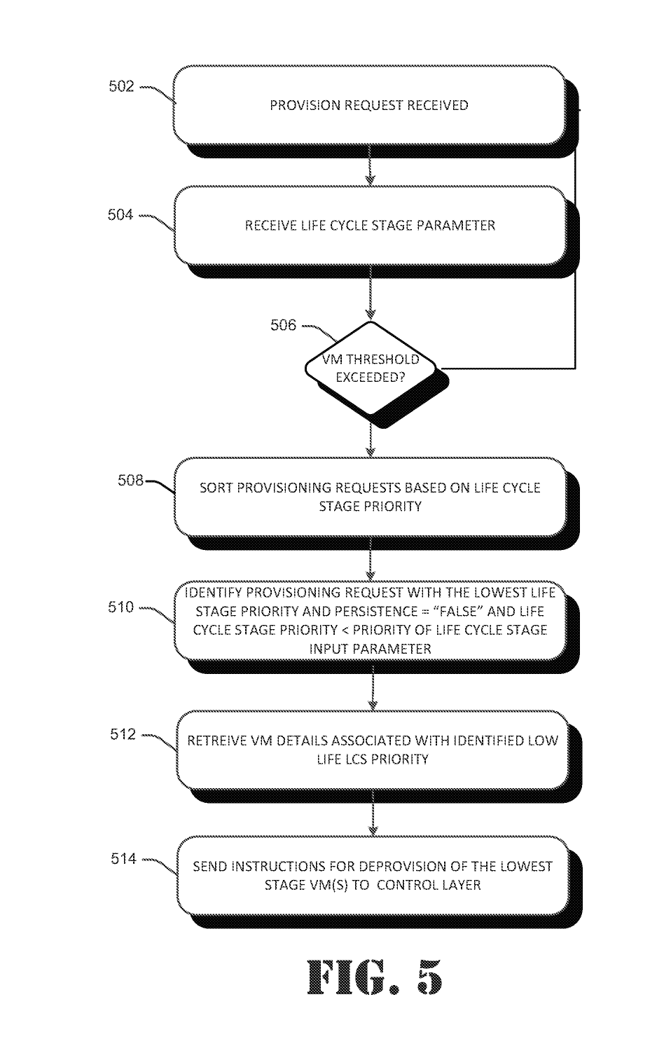

FIG. 5 illustrates a simplified flow chart of the processing steps for evaluating virtual machines within the virtual machine resource management system in accordance with an example implementation. In step 502, a provision request is received by the VM controller. As explained above, the VM controller is configured to create the appropriate VM and infrastructure through user selection of one of the available service templates provided by administrator. Moreover, the priority deprovisioner module is configured to accept a life cycle stage parameter associated with the requested service instance as input in step 504. In one example, the life cycle stage parameter governs the max life cycle stage (based on priority) that can be deprovisioned.

When the virtual resource threshold allocation has been exceeded in step 506, then the priority deprovisioner sorts all provisioning requests stored in a data structure based on the priority of the lifecycle stages in step 508. Thereafter, the priority of the life cycle stage parameter specified in the input are retrieved from the master data structure holding the priorities of life cycle stages. In step 510, the priority deprovisioner includes instructions to identify those virtual machines with a persistence value=“False” and a life cycle stage priority <=priority of the specified life cycle stage retrieved. Based on the retrieved data, the priority deprovision identifies/selects the provisioning request from the sorted data with the lowest life cycle stage priority (step 510) and retrieves the details of the VM(s) which were provisioned as part of the provisioning request in step 512. Next, in step 514, a request for deprovisioning the identified virtual machine is sent to the VM controller. Additionally, the identified low-priority provisioning request may be marked as deprovisioned so that VM is not considered again for deprovisioning.

In one implementation, VM sprawl may be monitored and controlled as part of every provisioning request. Here, user requests provisioning of virtual machines for a specific life cycle stage (e.g., staging environment with persistence set to “True”) (e.g., step 502). The provisioning request along with the lifecycle stage and persistence level is saved into the database (e.g., PMDB) (e.g., step 504). At the end of provisioning request, an asynchronous process may be triggered and the user may be notified with the details of the provisioned environment. The asynchronous process invokes the monitoring software to check if the resource capacity (e.g., storage, memory) or performance (e.g., slow I/O) related parameters have exceeded the threshold. If it is determined that the resource threshold is exceeded (e.g., step 506), then the priority deprovisioner module is activated by passing the current life cycle stage as the input parameter no that all life cycle stages with priorities <=to the current life cycle stage are considered for deprovisioning (e.g., steps 508 and 510). Lastly, the priority deprovisioner module sends instructions to deprovision the identified lower priority VMs (e.g., step 512). In the asynchronous process, the priority deprovisioning module may continually run until capacity or performance related parameters fall back below the predetermined threshold. As mentioned above, the respective owners of the virtual machines may be notified of the deprovisioning activity, and/or the virtual machines may be archived as part of the deprovisioning process so that the location of the archived instance is also communicated.

FIG. 6 illustrates a simplified flow chart of the processing steps for deprovisioning VMs within the virtual machine resource management system in accordance with an example implementation. In step 602, the VM evaluator polls the performance data in the performance management database relating to the service instance of one or more VMs. Thereafter, in step 604, the VM evaluator utilizes the information of the service instance and service catalog to check if a particular VM is under performing. If it is determined—based on the service instance and cross-referenced performance parameters—that the VM is no longer valid in step 606, then the VM evaluator triggers a workflow to backup and purge the identified VM in step 610. If on the other hand, if it is determined—based on the service instance and performance parameters—that the VM is underutilized in step 608, then the VM evaluator sends an instruction or workflow to the VM controller to reduce the virtual resources for that VM in step 612. The VM controller then activates the received workflow to modify (e.g., purge, backup, or reduce) the VM and release the virtual resources associated with that VM in step 614. More particularly, the VM controller may activate appropriate activities at the higher layers (e.g., hypervisor) to inform that the VM has been removed so that resources may be reallocated.

Implementations of the present disclosure provide virtual machines resource management system and method thereof. Moreover, many advantages are afforded by the virtual machine resource management system according to implementations of the present disclosure. For instance, since the VM evaluator analyzes the hosted service rather than just VM resource allocation, the VM evaluator can aid in reducing the number of stale VMs in an organization thus saving costs and critical resources. The VM Evaluator ensures all created VMs are used optimally and that all VMs are being used properly (i.e., no unnecessary resource wastes).

Furthermore, the present solution takes into consideration existing IaaS controller architecture and may be utilized to extend existing IaaS environment by incorporating elements of the present disclosure to make the solution user-friendly and time-efficient while also reducing manual effort and the errors associated therewith. These resources could be used for creating new VMs which deliver more value to an enterprise. Moreover, implementation of the present disclosure helps to ensure that VM Sprawl is kept in check by prioritizing VMs based on their lifecycle stages. And at any point in time, critical environments may still be immediately provisioned when required even though the datacenter capacity has reached its threshold limit and all VMs are active.

The present configuration may also encourage users to configure minimal VM's. For example, if VM resource policy is to allow only one high priority VM per user, this would force users to plan their activities more strategically thereby preventing redundant VM's. The present solution can also be configured based on the datacenter capacity. For example, if the datacenter capacity is very high, then the organization may decide to grant three or four high priority VMs to every user. On the other hand, if the data center capacity of an organization is very low, then the administrator can decide to grant only one high priority VM to each user. Moreover, implementation described herein can be configured to be non-intrusive in the sense that action is taken only when the virtual resource allocation reaches the predetermined threshold value.

The system described above includes distinct software modules, with each of the distinct software modules capable of being embodied on a tangible computer-readable recordable storage medium. All the modules (or any subset thereof) can be on the same medium, or each can be on a different medium, for example. The modules can include any or all of the components and are configured to run on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, include the virtual machines resource management of a cloud-based system with the distinct software modules.

Not all components, features, structures, characteristics, etc. described and illustrated herein need be included in a particular example or implementation. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some examples have been described in reference to particular implementations, other implementations are possible according to some examples. Additionally, the arrangement o order of elements or other features illustrated in the drawings or described herein need not be arranged in the particular way illustrated and described. Many other arrangements are possible according to some examples.

The techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

What is claimed is:

1. A computer-implemented method for virtual machine resource management comprising:
receiving a request for service provisioning, wherein the request includes a life cycle stage;
assigning a priority to the life cycle stage of the request;
creating at least one virtual machine associated with the request, wherein the at least one virtual machine includes service information; and
modifying at least one virtual machine of a plurality of virtual machines based on either the life cycle stage priority of the request or the service information associated with the virtual machine upon a determination that a virtual resource allocation has exceeded a threshold value.

2. The computer-implemented method of claim 1, further comprising:
sorting, via a priority deprovisioner, the virtual machines by the life cycle stage priority associated with the request upon determining that the virtual resource allocation has exceeded the threshold value.

3. The computer-implemented method of claim 2, wherein the virtual machine associated a request having the lowest life cycle stage priority or a life cycle stage priority lower than the life cycle stage priority of a current provision request is deprovisioned.

4. The computer-implemented method of claim 1, further comprising:
storing, via a resource monitor, in a database performance parameters associated with each of a plurality of virtual machines; and
polling, via the resource monitor, the performance parameters of each virtual machine at predetermined intervals.

5. The computer-implemented method of claim 4, further comprising:
removing an identified virtual machine from a hypervisor when the identified virtual machine is determined to be obsolete based on the performance parameters and service information.

6. The computer-implemented method of claim 4, further comprising:
reducing the resources of an identified virtual machine when the identified virtual machine is determined to be underutilized based on the performance parameters and service information.

7. The computer-implemented method of claim 4, wherein the performance parameters includes the service availability, service response time, access request count, and host virtual machine information.

8. The computer-implemented method of claim 3, further comprising:
assigning, via the priority deprovisioner, a persistence value to the each of the plurality of virtual machines.

9. The computer-implemented method of claim 8, wherein the virtual machine is deprovisioned based on the persistence value and the life cycle stage priority.

10. A virtual machine (VM) resource management system comprising:
a VM control layer to provision and deprovision a plurality of virtual machines based on received provisioning requests;
a resource monitor to monitor performance parameters associated with the virtual machines;
a database for storing performance parameters associated with a plurality of provisioned virtual machines;
an service evaluation module for evaluating service information and performance parameters associated with each of the provisioned virtual machines, and
a priority deprovisioner module configured to identify low priority provisioning request based on an assigned life cycle stage parameter;
wherein at least one virtual machine is modified based on the life cycle stage priority of an associated provisioning request or the service information and performance parameters associated with the at least one virtual machine upon determining that a virtual resource allocation has exceeded a threshold value.

11. The system of claim 10, wherein the priority deprovisioner module sorts the virtual machines by the life cycle stage priority upon determining that the virtual resource allocation has exceeded the threshold value.

12. The system of claim 11, wherein a virtual machine associated with a provisioning request having the lowest life cycle stage priority or a life cycle stage priority lower than a current provision request is deprovisioned.

13. The system of claim 10, wherein at least one of the plurality of virtual machines is removed from a host machine when the at least one virtual machine is determined to be obsolete based on the performance parameters and the service information associated with the at least one virtual machine.

14. The system of claim 10, wherein virtual resources allocated to at least one of the plurality of virtual machines are reduced when the virtual machine is determined to be underutilized based on the performance parameters and service information associated with the virtual machine.

15. A non-transitory computer readable medium having programmed instructions stored thereon for causing a processor to:
receive a provision request for service provisioning, wherein each provision request is assigned a life cycle stage priority;
create at least one virtual machine associated with the request, wherein the at least one virtual machine includes service information;
store the performance parameters of each of a plurality of virtual machines in a database;
monitor the performance parameters associated with a plurality of virtual machines; and
modify an identified virtual machine based on the life cycle stage priority of the request, the service instance, and performance parameters of the identified virtual machine upon determining that a virtual resource allocation has exceeded a threshold value,
wherein the identified virtual machine associated with a request having the lowest life cycle stage priority or a life cycle stage priority lower than a current provision request is deprovisioned,
wherein the identified virtual machine is removed from a host machine when the identified virtual machine is determined to be obsolete based on the performance parameters of the service information of the identified virtual machine,
wherein virtual resources associated with the identified virtual machine are reduced when the identified virtual machine is determined to be underutilized based on the performance parameters and service information.
